(19) United States
(12) Patent Application Publication
(10) Pub. No.: US 2021/0392255 A1
(43) Pub. Date: Dec. 16, 2021

(54) Foldable Display Viewfinder User Interface

(71) Applicant: Motorola Mobility LLC, Chicago, IL (US)

(72) Inventors: Xiaofeng Zhu, Nanjing (CN); John J. Gorsica, IV, Round Lake, IL (US); Alberto R. Cavallaro, Northbrook, IL (US)

(73) Assignee: Motorola Mobility LLC, Chicago, IL (US)

(21) Appl. No.: 16/918,572

(22) Filed: Jul. 1, 2020

(30) Foreign Application Priority Data
Jun. 10, 2020 (CN) 202010522381.5

(51) Int. Cl. H04N 5/225; H04N 5/232; H04N 5/247

(52) U.S. Cl. CPC H04N 5/225251; H04N 5/247; H04N 5/232935

(57) ABSTRACT

In aspects of a foldable display viewfinder user interface, a wireless device has a rear-facing camera to capture digital images, and has a foldable display screen to display a viewfinder user interface in which a camera preview image as captured by the rear-facing camera is displayable. The wireless device implements an image viewfinder module that can determine a semi-folded state of the foldable display screen, and the viewfinder user interface can be displayed on an approximate half section of the foldable display screen in the semi-folded state. The image viewfinder module can determine that an upper display section of the foldable display screen is not viewable in the semi-folded state of the foldable display screen, such as based on a camera image view from a front-facing camera, and the viewfinder user interface can then be displayed on a lower display section of the foldable display screen in the semi-folded state.

### RELATED APPLICATION

This application claims the priority benefit of China Patent Application for Invention Serial No. 202010522381.5 filed Jun. 10, 2020 entitled “Foldable Display Viewfinder User Interface”, the disclosure of which is incorporated by reference herein in its entirety.

### BACKGROUND

Devices such as smart devices, mobile devices (e.g., cellular phones, tablet devices, smartphones), consumer electronics, and the like can be implemented for use in a wide range of environments and for a variety of different applications. Different types of these devices, such as mobile phones, now include a foldable display screen that unfolds to an open position, or a partially open position, which enables a user to view a relatively large display. Many of these devices also include dual cameras to capture digital images, with one front-facing camera and at least one rear-facing camera. Generally, a lens of the front-facing camera is integrated in or around the display screen of a device, and the lens faces a user as he or she holds the device in a position to view the display screen. Users commonly use the front-facing camera to take pictures (e.g., digital images) of themselves, such as images often referred to as “selfies.” Generally, a lens of the rear-facing camera is integrated in the back cover or housing of the device and faces away from the user toward the surrounding environment, as seen from the point-of-view of the user. The rear-facing camera can also be used to capture photos (e.g., digital images) of the surrounding environment, as viewed by the user.

A user commonly holds a mobile device, such as a smartphone or tablet device, in a manner to use the rear-facing camera to capture photos at various angles relative to the user of the device and the subject of the photos. If the user positions the device at a low angle, or at any angle in which the subject is not generally at eye-level with the user of the device, then the user may not be able to see the display screen, and in particular, the viewfinder user interface that displays what the rear-facing camera is capturing. Using a device to capture low-angle images, for example, can make it difficult to be in a position where the user can see both the viewfinder user interface and achieve the desired angle of image capture. Notably, capturing images at high angles or in difficult-to-reach positions also presents similar problems.

### BRIEF DESCRIPTION OF THE DRAWINGS

Implementations of the techniques for a foldable display viewfinder user interface are described with reference to the following Figures. The same numbers may be used throughout to reference like features and components shown in the Figures:

FIG. 1 illustrates an example of techniques for a foldable display viewfinder user interface using a wireless device with front and rear-facing cameras in accordance with one or more implementations as described herein.

FIG. 2 illustrates an example wireless device that can be used to implement features and techniques for a foldable display viewfinder user interface as described herein.

FIG. 3 illustrates an example method of a foldable display viewfinder user interface in accordance with one or more implementations of the techniques described herein.

FIG. 4 illustrates an example method of a foldable display viewfinder user interface in accordance with one or more implementations of the techniques described herein.

FIG. 5 illustrates various components of an example device that can be used to implement the techniques for a foldable display viewfinder user interface as described herein.

### DETAILED DESCRIPTION

Implementations of a foldable display viewfinder user interface are described, and provide techniques implemented by a wireless device to facilitate a user of the device being able to view a viewfinder user interface of a camera view application that is displayed on a foldable display screen of the wireless device when positioning the device to capture low-angle images. The techniques described herein for a foldable display viewfinder user interface are applicable to using any type of a foldable device that has a foldable display screen, and a user positioning the device at any angle in which a camera subject is not generally at eye-level with the user of the device and the user may not be able to see the foldable display screen on the device. When a foldable wireless device is in a semi-open (or semi-closed) position and the user positions the device at a low angle, the user likely will not be able to see at least an upper display section of the foldable display screen. In particular, the user may not be able to see the viewfinder user interface that displays what the camera is capturing if the viewfinder user interface is displayed fully on the foldable display screen.

In aspects of a foldable display viewfinder user interface, a wireless device has a rear-facing camera to capture digital images, and has a foldable display screen to display a viewfinder user interface in which a camera preview image as captured by the rear-facing camera is displayable. Generally, the foldable display screen has a lower display section and an upper display section. In implementations, the foldable display screen may be a single, continuous display screen that is bifurcated or divided approximately in half sections along a foldable joint, such as into the lower display section and the upper display section. Alternatively, the foldable display screen may be two or more display screens implemented in concert to appear substantially as one continuous display screen that is foldable into the bifurcated or half sections of approximately equal size. Although generally shown and described herein as a foldable display screen having a lower display section and an upper display section, the features and techniques for a foldable display viewfinder user interface are similarly applicable for a device with a foldable display screen that folds side-by-side, or in the instance when a user may hold the device in a sideways position to capture a digital image.

The wireless device implements an image viewfinder module that can determine a semi-folded state of the foldable display screen, and the viewfinder user interface can be displayed on an approximate half section of the foldable display screen in the semi-folded state. The image viewfinder module can determine that an upper display section of the foldable display screen is not viewable in the semi-folded state of the foldable display screen, such as based on a camera image view from a front-facing camera, and the viewfinder user interface can then be displayed on a lower display section of the foldable display screen in the semi-folded state. Generally, the camera image view captured by the front-facing camera is digital content that may include an image of the face of the user of the device, or partial facial features and/or other features of the user or objects viewable within the field-of-view of the front-facing camera.

In implementations, the image viewfinder module can receive the camera image view as an input from the front-facing camera of the wireless device, and determine that a user of the device is not positioned to view the upper display section of the foldable display screen in the semi-folded state of the device. For example, the camera image view may only capture a portion of the user of the device, and not the user's face. The image viewfinder module can then determine that the user likely will not be able to see at least the upper display section of the foldable display screen when the wireless device is in the semi-folded (or semi-closed) position. In particular, the user may not be able to see the viewfinder user interface that displays what the rear-facing camera is capturing, and the image viewfinder module can initiate to display the viewfinder user interface on the lower display section of the foldable display screen. Similarly, the image viewfinder module can utilize the camera image view that shows the face of the user, and automatically shift or adjust the display of the viewfinder user interface on the foldable display screen based on a determined eye gaze of the user.

While features and concepts of a foldable display viewfinder user interface can be implemented in any number of different devices, systems, environments, and/or configurations, implementations of a foldable display viewfinder user interface are described in the context of the following example devices, systems, and methods.

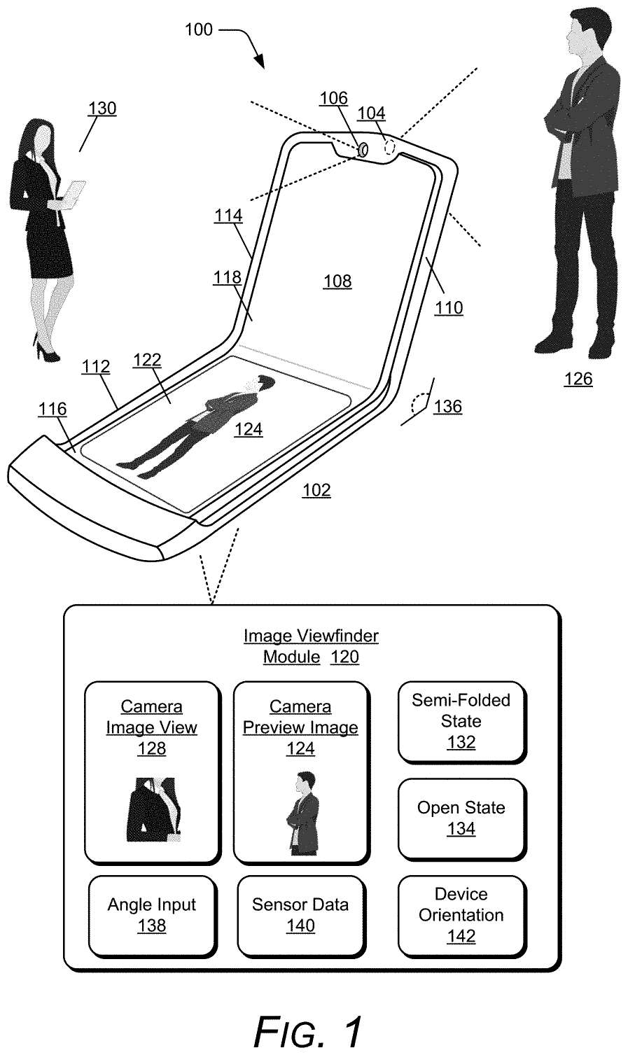

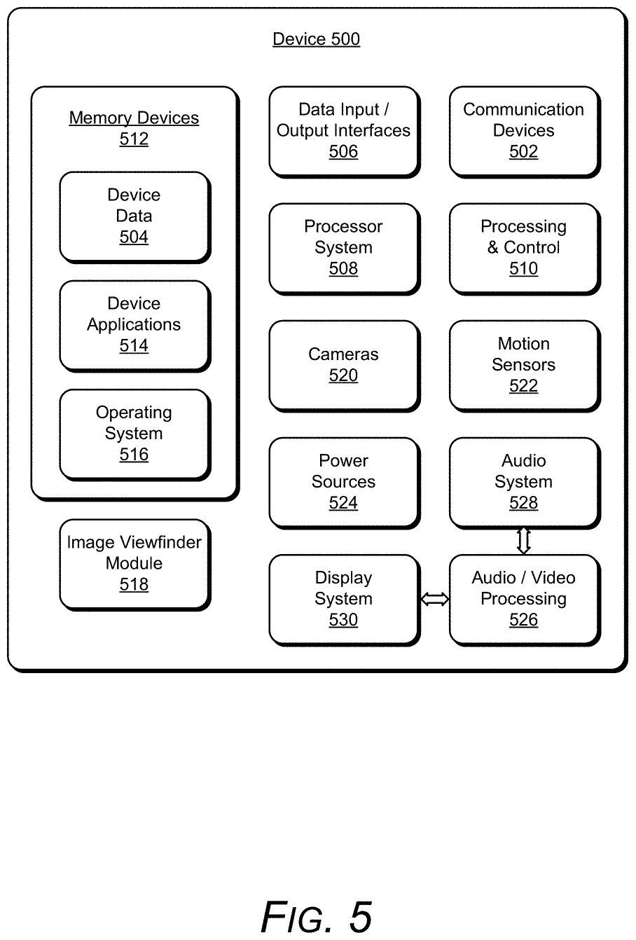

FIG. 1 illustrates an example 100 of techniques for a foldable display viewfinder user interface, such as implemented with a wireless device 102. In this example 100, the wireless device 102 may be any type of a mobile device, tablet device, computing device, mobile phone, flip phone, smartphone, and/or any other type of wireless device. Generally, the wireless device 102 may be any type of an electronic, computing, and/or communication device implemented with various components, such as a processor system and memory, as well as any number and combination of different components as further described with reference to the example device shown in FIG. 5. For example, the wireless device 102 can include a power source to power the device, such as a rechargeable battery and/or any other type of active or passive power source that may be implemented in an electronic, computing, and/or communication device.

In this example 100, the wireless device 102 has a rear-facing camera 104, a front-facing camera 106, and a foldable display screen 108 included in a device housing 110. Generally, the rear-facing camera 104 includes a lens that is integrated in the back cover or housing of the device, and faces away from a user of the device toward the surrounding environment. The rear-facing camera 106 also has an imaging sensor, referred to as an imager, that receives light directed through the camera lens, which is then captured as digital content, such as a digital photo or digital video content. For example, the digital content that is captured by the rear-facing camera 104 may be a digital photo of an environment as the field-of-view of the camera. As used herein, the term “digital content” includes any type of digital image, digital photograph, a digital video frame of a video clip, digital video, and any other type of digital content. A digital image that is captured with a camera device generally refers to the functions performed by the camera device to image a digital photo when initiated by a user of the device to photograph a person, object, or other type of subject.

Similarly, the front-facing camera 106 of the wireless device 102 includes a lens that is integrated in or around the foldable display screen 108 of the device, and the front-facing camera 106 generally faces the user of the device as he or she holds the device in a position to view the display screen. The front-facing camera 106 also has an imager that receives light directed through the camera lens, which is then captured as a digital image from a viewpoint opposite the rear-facing camera. Users commonly use the front-facing camera 106 to take pictures (e.g., digital images) of themselves, such as self-portrait digital images often referred to as “selfies.”

In implementations, the device housing 110 may operate to rotate or fold to a closed position, an open position, or a semi-folded position (i.e., a semi-closed or semi-open position, such as shown in this example 100). The device housing 110 includes a lower housing section 112 and an upper housing section 114. Generally, the foldable display screen 108 includes a lower display section 116 and an upper display section 118, each section located respectively within the lower housing section 112 and the upper housing section 114 on which the foldable display screen 108 is located. In implementations, the foldable display screen 108 may be a single, continuous display screen that is bifurcated or divided approximately in half sections along a foldable joint, such as into the lower display section 116 and the upper display section 118. Alternatively, the foldable display screen 108 may be two or more display screens implemented in concert to appear substantially as one continuous display screen that is foldable into the bifurcated or half sections of approximately equal size. As noted above, although the foldable display screen 108 is generally shown and described as having the lower display section 116 and the upper display section 118, the features and techniques for a foldable display viewfinder user interface are similarly applicable for a device with a foldable display screen that folds side-by-side, or in the instance when a user may hold the device in a sideways position to capture a digital image.

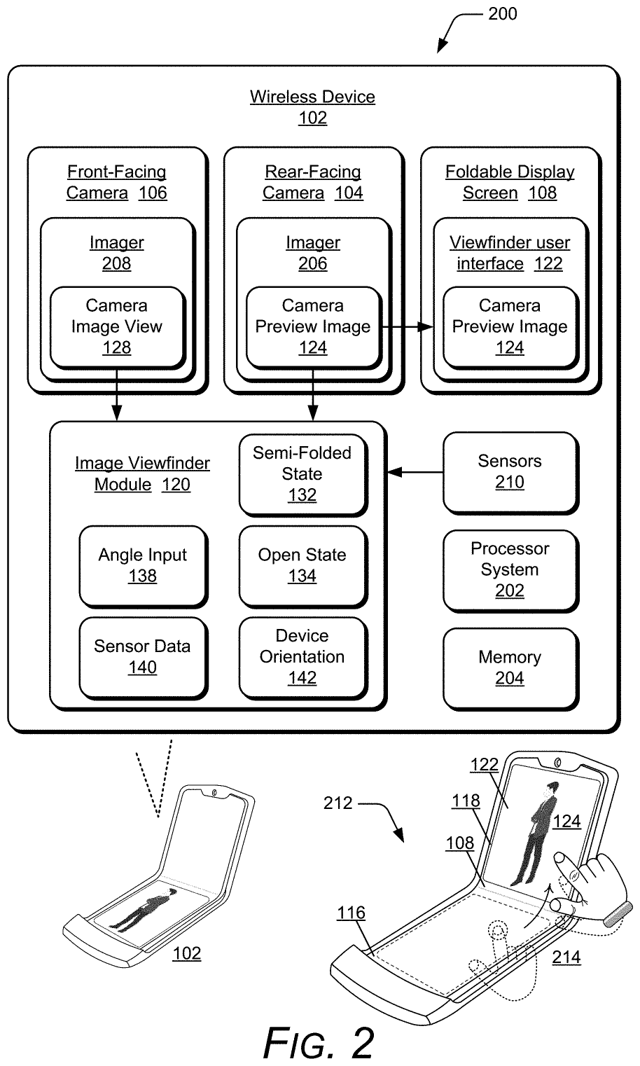

The wireless device 102 implements an image viewfinder module 120, which manages aspects and techniques for a foldable display viewfinder user interface, as described herein. As further shown and described with reference to FIG. 2, the image viewfinder module 120 can be implemented with independent processing, memory, and/or logic components functioning as a computing and/or electronic device integrated with the wireless device 102. Alternatively or in addition, the image viewfinder module 120 can be implemented as a software application or software module, such as integrated with an operating system and as computer-executable software instructions that are executable with a processor of the wireless device 102. As a software application or module, the image viewfinder module 120 can be stored in memory of the device, or in any other suitable memory device or electronic data storage implemented with the image viewfinder module. Alternatively or in addition, the image viewfinder module 120 may be implemented in firmware and/or at least partially in computer hardware. For example, at least part of the image viewfinder module 120 may be executable by a computer processor, and/or at least part of the image viewfinder module may be implemented in logic circuitry.

In implementations, the image viewfinder module 120 manages the display of a viewfinder user interface 122 on the foldable display screen 108 of the wireless device 102. In this example, a camera preview image 124, as captured by the rear-facing camera 104, is displayable on the foldable display screen 108 in the viewfinder user interface 122. The camera preview image 124 that is captured by the rear-facing camera 104 is a preview of the viewable subject 126 that may then be captured as a digital photo when initiated by the user of the device, such as the human subject in this example who is viewable from the perspective of the rear-facing camera. As displayed on the foldable display screen 108, the viewfinder user interface 122 can receive inputs and user selections such as, for example, touch inputs (e.g., on a touchscreen display), gesture inputs, or other types of user inputs.

The image viewfinder module 120 can also receive a camera image view 128 from the front-facing camera 106 of the wireless device 102. Generally, the camera image view 128 is digital content that may include an image of the face of the user of the device, or partial facial features and/or other features of the user or objects viewable within the field-of-view of the front-facing camera 106. As used herein, the terms “camera preview image” and “camera image view” can include any type of digital image, digital photograph, preview image, a digital video frame of a video clip, digital video, and any other type of digital content. The different terms “camera preview image” and “camera image view” are used merely for ease of description to differentiate the preview images captured by the respective rear-facing camera 104 and the front-facing camera 106.

As generally shown at 130, a user may hold the wireless device 102 in a manner to use the rear-facing camera to capture photos at various angles relative to the user of the device and the subject 126 of the photos. If the user positions the device at a low angle (e.g., held down low as shown at 130), or at any angle in which the subject is not generally at eye-level with the user of the device, then the user may not be able to see the foldable display screen 108 on the wireless device. Notably, the user will likely not be able to see at least the upper display section 118 of the foldable display screen 108 when the device is in a semi-open (or semi-closed) position. In particular, the user may not be able to see the viewfinder user interface 122 that displays what the rear-facing camera 104 is capturing if the viewfinder user interface is displayed fully on the foldable display screen (i.e., on both the lower display section 116 and the upper display section 118).

In implementations, the image viewfinder module 120 can determine a semi-folded state 132 of the wireless device 102, and initiate to display the viewfinder user interface 122 on a bifurcated or an approximate half section of the foldable display screen 108 in the semi-folded state, such as to display the viewfinder user interface 122 on the lower display section 116 of the foldable display screen. For example, the image viewfinder module 120 can determine the semi-folded state 132, or an open state 134, of the wireless device 102 based on an angle 136 of a foldable joint between the lower housing section 112 relative to the upper housing section 114 of the wireless device 102. The image viewfinder module 120 can receive the angle 136 of the foldable joint between the housing sections of the wireless device 102 as the angle input 138.

Alternatively or in addition, the image viewfinder module 120 can receive sensor data 140 that indicates a change in the angle 136 of the foldable joint between the housing sections of the wireless device 102. From the sensor data 140, the image viewfinder module 120 can determine a change in the foldable display screen 108 from the substantially open state 134 to the semi-folded state 132, or alternatively, from the semi-folded state 132 to the substantially open state 134. For example, sensors associated with the foldable joint of the device housing 110 can sense a change in the relative opening angle 136 of the foldable joint and communicate the angle input 138 to the image viewfinder module 120 as the respective sections of the device housing 110 are rotated between states of open, semi-open (or semi-folded), and closed. Alternatively or in addition, the sensor data 140 can include data from one or a combination of RFID sensors, proximity sensors, contact sensors, or other suitable sensors positioned in the lower housing section 112 and/or in the upper housing section 114 to detect when the wireless device 102 transitions from states of unfolded and open to folded, and vice-versa.

In implementations, the image viewfinder module 120 can receive the camera image view 128 as an input from the front-facing camera 106 of the wireless device 102, and determine that a user of the device is not positioned to view the upper display section 118 of the foldable display screen 108 in the semi-folded state of the device. For example, the camera image view 128 in this example 100 illustrates that the field-of-view of the front-facing camera 106 only captures a portion of the user at 130, and not her face. The image viewfinder module 120 can then determine that the user likely will not be able to see at least the upper display section 118 of the foldable display screen 108 when the wireless device is in the semi-folded (or semi-closed) position. In particular, the user may not be able to see the viewfinder user interface 122 that displays what the rear-facing camera 104 is capturing, and the image viewfinder module 120 can initiate to display the viewfinder user interface 122 on the lower display section 116 of the foldable display screen 108, as shown in this example. Similarly, the image viewfinder module 120 can utilize the camera image view 128 that shows the face of the user, and automatically shift or adjust the display of the viewfinder user interface 122 on the foldable display screen 108 based on a determined eye gaze of the user.

The image viewfinder module 120 can also receive the camera image view 128 as the input from the front-facing camera 106 of the wireless device 102, and determine a device orientation 142 of the device relative to using the rear-facing camera 104 to capture a digital image based on input of the camera image view 128 from the front-facing camera 106. For example, the image viewfinder module 120 can determine the device orientation 142 based on the sensor data 140, which in addition to the sensor discussion above, can include sensor data inputs from motion sensors, such as may be implemented in an inertial measurement unit (IMU). The motion sensors can be implemented with various sensors, such as a gyroscope, an accelerometer, and/or other types of motion sensors to sense position, velocity, and acceleration changes of the wireless device. An accelerometer input can be used by the image viewfinder module 120 to determine the difference between a low-angle mode and a high-angle mode of the wireless device 102 in a camera view mode.

Additionally, the viewfinder user interface 122 may be displayed fully on the foldable display screen 108 (i.e., on both the lower display section 116 and the upper display section 118). The image viewfinder module 120 can receive the sensor data 140 that indicates a change in the angle 136 of the foldable display screen 108, as corresponding to a change in the angle of the device housing, from substantially open (e.g., the open state 134) to the semi-folded state 132. The image viewfinder module 120 can then initiate to display the viewfinder user interface 122 on the approximate half section of the foldable display screen 108 based on the sensor data. For example, when a user partially closes the wireless device 102 from an open position, the image viewfinder module 120 can then initiate to display the viewfinder user interface 122 on an approximate half section of the foldable display screen 108, such as on the lower display section 116 or the upper display section 118, as appropriate to enable the user to see the camera preview image 124 in the viewfinder user interface 122.

Alternatively, the viewfinder user interface 122 may be displayed on an approximate half section of the foldable display screen 108, such as on the lower display section 116 or the upper display section 118. The image viewfinder module 120 can receive the sensor data 140 that indicates a change in the angle 136 of the foldable display screen 108, as corresponding to a change in the angle of the device housing, from the semi-folded state 132 to substantially open (e.g., the open state 134). The image viewfinder module 120 can then initiate to change the display of the viewfinder user interface 122 from the approximate half section of the foldable display screen 108 to display on substantially all of the foldable display screen. For example, when a user opens the wireless device 102 from a partially closed position, the image viewfinder module 120 can then initiate to display the viewfinder user interface 122 on the full display (i.e., on both the lower display section 116 and the upper display section 118 of the foldable display screen 108).

FIG. 2 further illustrates an example 200 of the wireless device 102 that can be used to implement the techniques of a foldable display viewfinder user interface, such as shown and described with reference to FIG. 1. In this example 200, the wireless device 102 may be any type of a computing device, tablet device, mobile phone, flip phone, wearable device, or any other type of portable electronic and/or mobile device. Generally, the wireless device 102 may be any type of an electronic and/or computing device implemented with various components, such as a processor system 202, to include an integrated or independent video graphics processor, and memory 204, as well as any number and combination of different components as further described with reference to the example device shown in FIG. 5. For example, the wireless device 102 can include a power source to power the device, such as a rechargeable battery and/or any other type of active or passive power source that may be implemented in an electronic and/or computing device.

In implementations, the wireless device 102 may be a mobile phone (also commonly referred to as a “smartphone”) implemented as a dual-camera wireless device. The wireless device 102 includes the rear-facing camera 104 and the front-facing camera 106. Although the devices are generally described herein as dual-camera devices having two cameras, any one or more of the devices may include more than two cameras. For example, an implementation of the rear-facing camera 104 may include two or three individual cameras itself, such as to capture digital content at different focal lengths, different apertures, or from different angles approximately simultaneously.

In this example 200, the rear-facing camera 104 includes an imager 206 to capture digital content of a camera preview image 124, such as a digital photo or digital video content as described with reference to FIG. 1. For example, the camera preview image 124 that is captured by the rear-facing camera 104 may be a digital image of a human subject (e.g., subject 126) as viewable when the wireless device 102 is held lower at approximately waist-level by the user, which presents a low angle perspective and field-of-view with the rear-facing camera 104. The digital content that is captured with the rear-facing camera 104 of the wireless device 102 is an example of the camera preview image 124 that is displayable in the viewfinder user interface 122 on an approximate half section or substantially all of the foldable display screen 108 of the wireless device 102.

Similarly, the front-facing camera 106 includes an imager 208 to capture a digital image as the camera image view 128 from a viewpoint opposite the rear-facing camera 104. Generally, the camera image view 128 may include depictions of one or more objects, to include an image of a user of the device and/or objects viewable within the field-of-view of the front-facing camera 106. The camera image view 128 that is captured with the front-facing camera 106 of the wireless device 102 as a self-image from the viewpoint of the user holding the device and facing the camera is an example of the camera image view 128 that may be captured by the front-facing camera 106 of the wireless device. In implementations, the imager 206 of the rear-facing camera 104 and the imager 208 of the front-facing camera 106 can be operational together to capture the respective camera preview image 124 and the camera image view 128 approximately simultaneously.

In this example 200, the wireless device 102 includes the image viewfinder module 120 that implements the features of a foldable display viewfinder user interface, as described herein and generally as shown and described with reference to FIG. 1. The image viewfinder module 120 may be implemented as a module that includes independent processing, memory, and/or logic components functioning as a computing and/or electronic device integrated with the wireless device 102. Alternatively or in addition, the image viewfinder module 120 can be implemented as a software application or software module, such as integrated with an operating system and as computer-executable software instructions that are executable with a processor (e.g., with the processor system 202) of the wireless device 102. As a software application or module, the image viewfinder module 120 can be stored on computer-readable storage memory (e.g., the memory 204 of the device), or in any other suitable memory device or electronic data storage implemented with the image viewfinder module. Alternatively or in addition, the image viewfinder module 120 may be implemented in firmware and/or at least partially in computer hardware. For example, at least part of the image viewfinder module 120 may be executable by a computer processor, and/or at least part of the image viewfinder module 120 may be implemented in logic circuitry.

In implementations of a foldable display viewfinder user interface, the image viewfinder module 120 can determine a semi-folded state 132 of the foldable display screen 108 of the wireless device 102. As described above, the image viewfinder module 120 can receive an angle input 138 and/or sensor data 140 to indicate an angle or change in the angle of the foldable display screen 108, as corresponding to the device housing being opened or folded closed. For example, the image viewfinder module 120 can receive the sensor data 140 from device sensors 210. Based on the angle input 138 and/or the sensor data 140, the image viewfinder module 120 can initiate to display the viewfinder user interface 122 on an approximate half section of the foldable display screen 108. The image viewfinder module 120 can determine a change in the foldable display screen 108 from the substantially open state 134 to the semi-folded state 132, or alternatively, from the semi-folded state 132 to the substantially open state 134. For example, sensors associated with the foldable joint of the device housing 110 can sense a change in the relative opening angle 136 of the foldable joint and communicate the angle input 138 to the image viewfinder module 120 as the respective sections of the device housing 110 are rotated between states of open, semi-open (or semi-folded), and closed.

The viewfinder user interface 122 may be displayed fully on the foldable display screen 108 (i.e., on both the lower display section 116 and the upper display section 118). For example, a user may initiate a camera view application on the wireless device 102 while the device is in an open position, and the viewfinder user interface 122 is then displayed fully on the foldable display screen 108. The image viewfinder module 120 can receive an input corresponding to a change in the angle 136 of the device housing, from substantially open (e.g., the open state 134) to the semi-folded state 132. The image viewfinder module 120 can then initiate to display the viewfinder user interface 122 on the approximate half section of the foldable display screen 108 based on the sensor data. For example, when the user partially closes the wireless device 102 from an open position, the image viewfinder module 120 can then initiate to display the viewfinder user interface 122 on an approximate half section of the foldable display screen 108, such as on the lower display section 116 or the upper display section 118, as appropriate to enable the user to see the camera preview image 124 in the viewfinder user interface 122.

Alternatively, the viewfinder user interface 122 may be displayed on an approximate half section of the foldable display screen 108, such as on the lower display section 116 or the upper display section 118. For example, the user may initiate the camera view application on the wireless device 102 while the device is in a semi-open (or semi-folded) position, and the viewfinder user interface 122 is then displayed on a half section of the foldable display screen 108, such as on the lower display section 116 or the upper display section 118. The image viewfinder module 120 can receive an input that indicates a change in the angle 136 of the foldable display screen 108, as corresponding to a change in the angle of the device housing, from the semi-folded state 132 to substantially open (e.g., the open state 134). The image viewfinder module 120 can then initiate to change the display of the viewfinder user interface 122 from the approximate half section of the foldable display screen 108 to display on substantially all of the foldable display screen. For example, when a user opens the wireless device 102 from a partially closed position, the image viewfinder module 120 can then initiate to display the viewfinder user interface 122 on the full display (i.e., on both the lower display section 116 and the upper display section 118 of the foldable display screen 108).

In implementations, the image viewfinder module 120 can receive the camera image view 128 as an input from the front-facing camera 106 of the wireless device 102, and determine that a user of the device is not positioned to view the upper display section 118 of the foldable display screen 108 in the semi-folded state of the device. For example, the image viewfinder module 120 can utilize facial recognition techniques to detect whether the face of the user is within the field-of-view of the front-facing camera 106 in the semi-folded state 132 of the device, and in the absence a detected face, the image viewfinder module 120 can initiate to display of the viewfinder user interface 122 on the lower display section 116 of the foldable display screen 108. The image viewfinder module 120 determines that the user likely will not be able to see at least the upper display section 118 of the foldable display screen 108 when the wireless device is in the semi-folded (or semi-closed) position. In particular, the user may not be able to see the viewfinder user interface 122 that displays what the rear-facing camera 104 is capturing, and the image viewfinder module 120 can initiate to display the viewfinder user interface 122 on the lower display section 116 of the foldable display screen 108. Similarly, the image viewfinder module 120 can utilize the camera image view 128 that shows the face of the user, and automatically shift or adjust the display of the viewfinder user interface 122 on the foldable display screen 108 based on a determined eye gaze of the user.

Similarly, the image viewfinder module 120 can also receive the camera image view 128 as the input from the front-facing camera 106 of the wireless device 102, and determine the device orientation 142 of the device relative to using the rear-facing camera 104 to capture a digital image based on input of the camera image view 128 from the front-facing camera 106. For instance, the image viewfinder module 120 can receive the digital content of the camera image view 128 from the front-facing camera 106, and process the image data of captured environmental features (e.g., background, horizon, sun or sky position, etc.), building structures, facial features of the user, or other features. These features can then be used by the image viewfinder module 120 to compare with the digital content of the camera preview image 124 captured by the rear-facing camera 104, and determine the device orientation 142 of the wireless device 102. Alternatively or in addition, the image viewfinder module 120 can determine the device orientation 142 as discussed in conjunction with the angle input 138 and/or the sensor data 140.

In implementations, the image viewfinder module 120 can initiate to display the camera preview image 124 in a periscopic viewing mode based on the determined device orientation 142 of the wireless device 102. For example, a user may hold the device in a partially closed position (i.e., a semi-folded state 132) with the device orientation 142 positioned to enable the user viewing the viewfinder user interface 122 while the field-of-view of the rear-facing camera 104 is positioned to capture the camera preview image 124 beyond or around obstructions. For example, the user may hold the device in a position to capture a digital image around a wall, above an elevated surface, below a ledge (e.g., under furniture, shelves, or other relatively low structures), and/or in any area in which it may be difficult for a user to reach or access (e.g., a vehicle engine bay, behind objects, or other confined areas). The camera preview image 124 that is displayed on the viewfinder user interface 122 can be rotated by the image viewfinder module 120 to provide the user an appropriate viewable orientation regardless of the determined device orientation 142. Additionally, the periscopic viewing mode can be implemented for use with any light and camera integrated in the wireless device 102. Further, the image viewfinder module 120 can be implemented to change one or more camera settings (e.g., focal length, exposure, contrast, brightness, illumination, etc.) to enable the user to view or search for objects in dark or cluttered environments.

In implementations, the image viewfinder module 120 can receive a user-selectable input, such as a touch input (e.g., on a touchscreen display), a gesture input, or other type of input, as shown in an example at 212, to select having the viewfinder user interface 122 displayed on the lower display section 116 or the upper display section 118 of the foldable display screen 108. For example, a user can initiate a touchscreen input 214 to change the section of the foldable display screen 108 on which the viewfinder user interface 122 is displayed, such as by moving the viewfinder user interface from the lower display section 116 to the upper display section 118, or vice-versa. Additionally, the user of the device can manually override the display position of the viewfinder user interface 122, as initiated for display by the image viewfinder module 120, such as to gain a better view of the foldable display screen 108 on the device.

In similar implementations, a user can place the wireless device 102 in the semi-folded state 132 on a surface, such as on a table or on the ground, while viewing the viewfinder user interface 122 on the lower display section 116 for positioning the rear-facing camera 104 to capture a digital image. The image viewfinder module 120 can be implemented to then use a timer mechanism or receive a gesture or audible command to initiate the image capture.

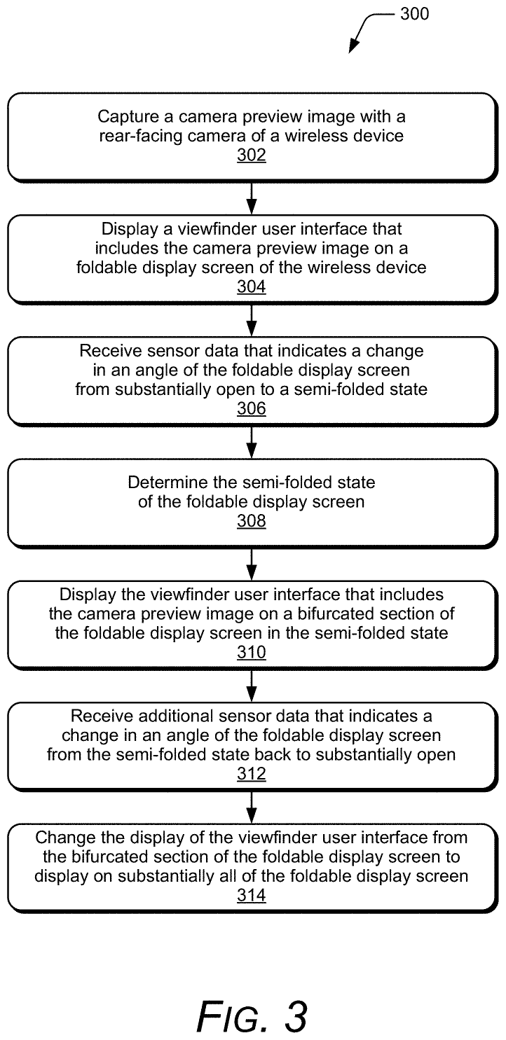

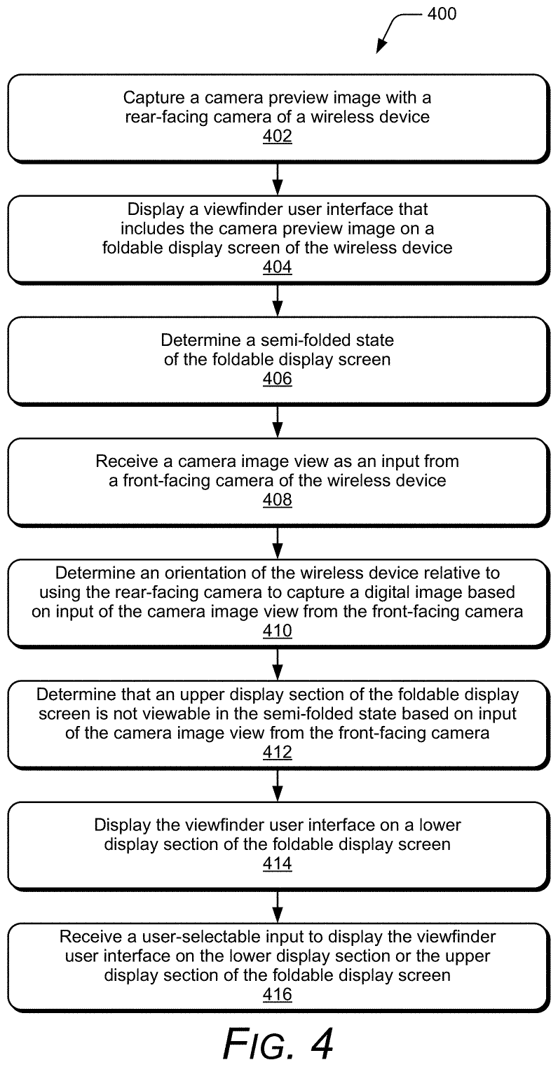

Example methods 300 and 400 are described with reference to respective FIGS. 3 and 4 in accordance with implementations of a foldable display viewfinder user interface. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 of a foldable display viewfinder user interface, and is generally described with reference to a wireless device and an image viewfinder module implemented by the device. The order in which the method is described is not intended to be construed as a limitation, and any number or combination of the described method operations can be performed in any order to perform a method, or an alternate method.

At 302, a camera preview image is captured with a rear-facing camera of a wireless device. For example, the rear-facing camera 104 of the wireless device 102 captures the camera preview image 124 as a preview of the viewable subject 126 that may then be captured as a digital photo when initiated by the user of the device, such as the human subject who is viewable from the perspective of the rear-facing camera.

At 304, a viewfinder user interface is displayed and includes the camera preview image on a foldable display screen of the wireless device. For example, the foldable display screen 108 of the wireless device 102 displays the viewfinder user interface 122, and the camera preview image 124, as captured by the rear-facing camera 104, is displayable on the foldable display screen 108 in the viewfinder user interface 122.

At 306, sensor data is received that indicates a change in an angle of the foldable display screen from substantially open to a semi-folded state. For example, the image viewfinder module 120 implemented by the wireless device 102 receives the sensor data 140 that indicates a change in the angle 136 of the foldable display screen 108, as corresponding to a change in the angle of the device housing, from substantially open (e.g., the open state 134) to the semi-folded state 132.

At 308, the semi-folded state of the foldable display screen is determined based on the sensor data. For example, the image viewfinder module 120 that is implemented by the wireless device 102 determines the semi-folded state 132 of the foldable display screen 108 based on the sensor data 140. The sensors 210 associated with the foldable joint of the device housing 110 can sense a change in the relative opening angle 136 of the foldable joint and communicate the angle input 138 to the image viewfinder module 120 as the respective sections of the device housing 110 are rotated between states of open, semi-open (or semi-folded), and closed.

At 310, the viewfinder user interface that includes the camera preview image is displayed on a bifurcated section of the foldable display screen in the semi-folded state. For example, the viewfinder user interface 122 may be displayed fully on the foldable display screen 108 (i.e., on both the lower display section 116 and the upper display section 118), such as when a user of the wireless device 102 initiates a camera view application while the device is in an open position, and the viewfinder user interface 122 is then displayed fully on the foldable display screen 108. The image viewfinder module 120 implemented by the wireless device 102 can then initiate to display the viewfinder user interface 122 on a bifurcated section (or approximate half section) of the foldable display screen 108 based on the received sensor data 140 that indicates the change in the angle 136 of the device housing, such as from substantially open (e.g., the open state 134) to the semi-folded state 132. For example, when the user partially closes the wireless device 102 from an open position, the image viewfinder module 120 can then initiate to display the viewfinder user interface 122 on an approximate half section of the foldable display screen 108, such as on the lower display section 116 or the upper display section 118, as appropriate to enable the user to see the camera preview image 124 in the viewfinder user interface 122.

At 312, additional sensor data is received that indicates a change in an angle of the foldable display screen from the semi-folded state back to substantially open. For example, the image viewfinder module 120 implemented by the wireless device 102 can receive an angle input 138 and/or sensor data 140 to indicate an angle or change in the angle of the foldable display screen 108, as corresponding to the device housing being opened or folded closed. The user of the wireless device 102 may initiate the camera view application while the device is in a semi-open (or semi-folded) position, and the viewfinder user interface 122 is then displayed on a half section of the foldable display screen 108, such as on the lower display section 116 or the upper display section 118. The image viewfinder module 120 can receive an input that indicates a change in the angle 136 of the foldable display screen 108, as corresponding to a change in the angle of the device housing, from the semi-folded state 132 to substantially open (e.g., the open state 134).

At 314, the display of the viewfinder user interface is changed from the bifurcated section of the foldable display screen to display on substantially all of the foldable display screen. For example, the image viewfinder module 120 implemented by the wireless device 102 initiates to change the display of the viewfinder user interface 122 from the bifurcated section (or approximate half section) of the foldable display screen 108 to display on substantially all of the foldable display screen. When a user opens the wireless device 102 from a partially closed position, the image viewfinder module 120 can then initiate to display the viewfinder user interface 122 on the full display (i.e., on both the lower display section 116 and the upper display section 118 of the foldable display screen 108).

FIG. 4 illustrates example method(s) 400 of a foldable display viewfinder user interface, and is generally described with reference to a wireless device and an image viewfinder module implemented by the device. The order in which the method is described is not intended to be construed as a limitation, and any number or combination of the described method operations can be performed in any order to perform a method, or an alternate method.

At 402, a camera preview image is captured with a rear-facing camera of a wireless device. For example, the rear-facing camera 104 of the wireless device 102 captures the camera preview image 124 as a preview of the viewable subject 126 that may then be captured as a digital photo when initiated by the user of the device, such as the human subject who is viewable from the perspective of the rear-facing camera.

At 404, a viewfinder user interface is displayed that includes the camera preview image on a foldable display screen of the wireless device. For example, the foldable display screen 108 of the wireless device 102 displays the viewfinder user interface 122, and the camera preview image 124, as captured by the rear-facing camera 104, is displayable on the foldable display screen 108 in the viewfinder user interface 122.

At 406, a semi-folded state of the foldable display screen is determined. For example, the image viewfinder module 120 implemented by the wireless device 102 determines the semi-folded state 132 of the foldable display screen 108, such as based on a received angle input 138 and/or sensor data 140 that indicates an angle or change in the angle of the foldable display screen 108, as corresponding to the device housing being opened or folded closed.

At 408, a camera image view is received as an input from a front-facing camera of the wireless device. For example, the image viewfinder module 120 of the wireless device 102 receives the camera image view 128 as an input from the front-facing camera 106 of the device.

At 410, an orientation of the wireless device relative to using the rear-facing camera to capture a digital image is determined based on input of the camera image view from the front-facing camera. For example, the image viewfinder module 120 of the wireless device 102 determines the device orientation 142 of the device relative to using the rear-facing camera 104 to capture a digital image based on input of the camera image view 128 from the front-facing camera 106. For instance, the image viewfinder module 120 receives the camera image view 128 from the front-facing camera 106, and processes the image data of captured environmental features (e.g., background, horizon, sun or sky position, etc.), building structures, facial features of the user, or other features. These features can then be used by the image viewfinder module 120 to compare with the camera preview image 124 captured by the rear-facing camera 104, and determine the device orientation 142 of the wireless device 102. Additionally, the image viewfinder module 120 can determine the orientation 142 of the wireless device 102 based on the sensor data 140.

At 412, an upper display section of the foldable display screen is determined as not viewable in the semi-folded state based on input of the camera image view from the front-facing camera. For example, the image viewfinder module 120 of the wireless device 102 determines that the upper display section 118 of the foldable display screen 108 is not viewable in the semi-folded state 132, such as by a user of the device. The image viewfinder module 120 can utilize facial recognition techniques to detect whether the face of the user is within the field-of-view of the front-facing camera 106 in the semi-folded state 132 of the device, and in the absence a detected face, the image viewfinder module 120 determines that a user of the device is not positioned to view the upper display section 118 of the foldable display screen 108 in the semi-folded state of the device.

At 414, the viewfinder user interface is displayed on a lower display section of the foldable display screen. For example, the image viewfinder module 120 implemented by the wireless device 102 initiates to display of the viewfinder user interface 122 on the lower display section 116 of the foldable display screen 108.

At 416, a user-selectable input is received to display the viewfinder user interface on the lower display section or the upper display section of the foldable display screen. For example, the image viewfinder module 120 implemented by the wireless device 102 receives a user-selectable input, such as a touch input (e.g., on a touchscreen display), a gesture input, or other type of input, to select having the viewfinder user interface 122 displayed on the lower display section 116 or the upper display section 118 of the foldable display screen 108. A user can initiate the touchscreen input 214 to change the section of the foldable display screen 108 on which the viewfinder user interface 122 is displayed, such as by moving the viewfinder user interface from the lower display section 116 to the upper display section 118, or vice-versa. Additionally, the user of the device can manually override the display position of the viewfinder user interface 122, as initiated for display by the image viewfinder module 120, such as to gain a better view of the foldable display screen 108 on the device.

FIG. 5 illustrates various components of an example device 500, which can implement aspects of foldable display viewfinder user interface, as described herein. The example device 500 can be implemented as any of the devices described with reference to the previous FIGS. 1-4, such as any type of a wireless device, mobile device, mobile phone, flip phone, client device, companion device, paired device, display device, tablet, computing, communication, entertainment, gaming, media playback, and/or any other type of computing and/or electronic device. For example, the wireless device 102 described with reference to FIGS. 1-4 may be implemented as the example device 500.

The example device 500 can include various, different communication devices 502 that enable wired and/or wireless communication of device data 504 with other devices. The device data 504 can include any of the various devices data and content that is generated, processed, determined, received, stored, and/or transferred from one computing device to another, and/or synched between multiple computing devices. Generally, the device data 504 can include any form of audio, video, image, graphics, and/or electronic data that is generated by applications executing on a device. The communication devices 502 can also include transceivers for cellular phone communication and/or for any type of network data communication.

The example device 500 can also include various, different types of data input/output (I/O) interfaces 506, such as data network interfaces that provide connection and/or communication links between the devices, data networks, and other devices. The I/O interfaces 506 can be used to couple the device to any type of components, peripherals, and/or accessory devices, such as a computer input device that may be integrated with the example device 500. The I/O interfaces 506 may also include data input ports via which any type of data, information, media content, communications, messages, and/or inputs can be received, such as user inputs to the device, as well as any type of audio, video, image, graphics, and/or electronic data received from any content and/or data source.

The example device 500 includes a processor system 508 of one or more processors (e.g., any of microprocessors, controllers, and the like) and/or a processor and memory system implemented as a system-on-chip (SoC) that processes computer-executable instructions. The processor system may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that may be implemented in connection with processing and control circuits, which are generally identified at 510. The example device 500 may also include any type of a system bus or other data and command transfer system that couples the various components within the device. A system bus can include any one or combination of different bus structures and architectures, as well as control and data lines.

The example device 500 also includes memory and/or memory devices 512 (e.g., computer-readable storage memory) that enable data storage, such as data storage devices implemented in hardware that can be accessed by a computing device, and that provide persistent storage of data and executable instructions (e.g., software applications, programs, functions, and the like). Examples of the memory devices 512 include volatile memory and non-volatile memory, fixed and removable media devices, and any suitable memory device or electronic data storage that maintains data for computing device access. The memory devices 512 can include various implementations of random-access memory (RAM), read-only memory (ROM), flash memory, and other types of storage media in various memory device configurations. The example device 500 may also include a mass storage media device.

The memory devices 512 (e.g., as computer-readable storage memory) provide data storage mechanisms, such as to store the device data 504, other types of information and/or electronic data, and various device applications 514 (e.g., software applications and/or modules). For example, an operating system 516 can be maintained as software instructions with a memory device and executed by the processor system 508 as a software application. The device applications 514 may also include a device manager, such as any form of a control application, software application, signal-processing and control module, code that is specific to a particular device, a hardware abstraction layer for a particular device, and so on.

In this example, the device 500 includes an image viewfinder module 518 that implements various aspects of the described features and techniques for selectable response options displayed based-on device grip position. The image viewfinder module may be implemented with hardware components and/or in software as one of the device applications 514, such as when the example device 500 is implemented as the wireless device 102 described with reference to FIGS. 1-4. An example of the image viewfinder module 518 includes the image viewfinder module 120 that is implemented by the wireless device 102, such as a software application and/or as hardware components in the wireless device. In implementations, the image viewfinder module 518 may include independent processing, memory, and logic components as a computing and/or electronic device integrated with the example device 500.

The example device 500 can also include cameras 520 and/or motion sensors 522, such as may be implemented as components of an inertial measurement unit (IMU). The motion sensors 522 can be implemented with various sensors, such as a gyroscope, an accelerometer, and/or other types of motion sensors to sense motion of the device. The motion sensors 522 can generate sensor data vectors having three-dimensional parameters (e.g., rotational vectors in x, y, and z-axis coordinates) indicating location, position, acceleration, rotational speed, and/or orientation of the device. The example device 500 can also include one or more power sources 524, such as when the device is implemented as a wireless device and/or mobile device. The power sources may include a charging and/or power system, and can be implemented as a flexible strip battery, a rechargeable battery, a charged super-capacitor, and/or any other type of active or passive power source.

The example device 500 can also include an audio and/or video processing system 526 that generates audio data for an audio system 528 and/or generates display data for a display system 530. The audio system and/or the display system may include any types of devices that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 500. Alternatively, the audio system and/or the display system are external, peripheral components to the example device.

Although implementations of a foldable display viewfinder user interface have been described in language specific to features and/or methods, the subject of the appended claims is not necessarily limited to the specific features or methods described. Rather, the specific features and methods are disclosed as example implementations of a foldable display viewfinder user interface, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A wireless device, comprising: a rear-facing camera to capture digital images; a foldable display screen to display a viewfinder user interface in which a camera preview image as captured by the rear-facing camera is displayable; an image viewfinder module implemented at least partially in hardware to determine a semi-folded state of the foldable display screen; and initiate to display the viewfinder user interface on an approximate half section of the foldable display screen in the semi-folded state.

Alternatively or in addition to the above described wireless device, any one or combination of: the foldable display screen includes a lower display section and an upper display section; and the image viewfinder module initiates to display the viewfinder user interface on one of the lower display section or the upper display section. The image viewfinder module is configured to receive a camera image view as an input from a front-facing camera of the wireless device; determine that a user of the wireless device is not positioned to view the upper display section of the foldable display screen in the semi-folded state based on input of the camera image view from the front-facing camera; and initiate the display of the viewfinder user interface on the lower display section of the foldable display screen. The image viewfinder module is configured to receive a camera image view as an input from a front-facing camera of the wireless device; and determine an orientation of the wireless device relative to using the rear-facing camera to capture a digital image based on input of the camera image view from the front-facing camera. The image viewfinder module is configured to receive a user-selectable input to display the viewfinder user interface on the lower display section or the upper display section of the foldable display screen. A device housing is operable to rotate a first housing section relative to a second housing section to one of a closed position, an open position, or a semi-open position of the wireless device; wherein the foldable display screen includes a first display in the first housing section and a second display in the second housing section; and the image viewfinder module initiates to display the viewfinder user interface on one of the first display or the second display in the semi-open position of the wireless device. The image viewfinder module is configured to receive an angle input that indicates an angle of the semi-folded state of the foldable display screen; and initiate to display the viewfinder user interface on the approximate half section of the foldable display screen based on the angle input. The image viewfinder module is configured to receive sensor data that indicates a change in an angle of the foldable display screen from substantially open to the semi-folded state; and initiate to display the viewfinder user interface on the approximate half section of the foldable display screen based on the sensor data. The image viewfinder module is configured to receive sensor data that indicates a change in an angle of the foldable display screen from the semi-folded state to substantially open; and initiate to change the display of the viewfinder user interface from the approximate half section of the foldable display screen to display on substantially all of the foldable display screen based on the sensor data. The image viewfinder module is configured to receive sensor data and determine an orientation of the wireless device; and initiate to display the camera preview image in a periscopic viewing mode of the viewfinder user interface.

A method, comprising: capturing a camera preview image with a rear-facing camera of a wireless device; displaying a viewfinder user interface that includes the camera preview image on a foldable display screen of the wireless device; determining a semi-folded state of the foldable display screen; and displaying the viewfinder user interface that includes the camera preview image on a bifurcated section of the foldable display screen in the semi-folded state.

Alternatively or in addition to the above described method, any one or combination of: the method further comprising receiving a camera image view as an input from a front-facing camera of the wireless device; determining that a user of the wireless device is not positioned to view an upper display section of the foldable display screen in the semi-folded state based on input of the camera image view from the front-facing camera; and initiating the display of the viewfinder user interface on a lower display section of the foldable display screen. The method further comprising receiving a camera image view as an input from a front-facing camera of the wireless device; and determining an orientation of the wireless device relative to using the rear-facing camera to capture a digital image based on input of the camera image view from the front-facing camera. The method further comprising receiving a user-selectable input to display the viewfinder user interface on a lower display section or an upper display section of the foldable display screen. The method further comprising receiving sensor data that indicates a change in an angle of the foldable display screen from substantially open to the semi-folded state; and displaying the viewfinder user interface on the bifurcated section of the foldable display screen based on the sensor data. The method further comprising receiving sensor data that indicates a change in an angle of the foldable display screen from the semi-folded state to substantially open; and changing the display of the viewfinder user interface from the bifurcated section of the foldable display screen to display on substantially all of the foldable display screen based on the sensor data. The method further comprising determining an orientation of the wireless device based on sensor data; and displaying the camera preview image in a periscopic viewing mode of the viewfinder user interface.

A system, comprising: a rear-facing camera to capture a camera preview image; a front-facing camera to capture a camera image view; a foldable display screen to display a viewfinder user interface in which the camera preview image as captured by the rear-facing camera is displayable; an image viewfinder module implemented at least partially in hardware to determine that an upper display section of the foldable display screen is not viewable in a semi-folded state of the foldable display screen based on the camera image view from the front-facing camera; and initiate to display the viewfinder user interface in which the camera preview image is displayed on a lower display section of the foldable display screen in the semi-folded state.

Alternatively or in addition to the above described system, any one or combination of: the image viewfinder module is configured to receive an angle input that indicates an angle of the semi-folded state of the foldable display screen; and initiate to display the viewfinder user interface on the lower display section of the foldable display screen based on the angle input. The image viewfinder module is configured to receive sensor data that indicates a change in a configuration of the foldable display screen from substantially open to the semi-folded state; and initiate to display the viewfinder user interface on the lower display section of the foldable display screen based on the sensor data.

1. A wireless device, comprising:
a rear-facing camera to capture digital images;
a foldable display screen to display a viewfinder user interface in which a camera preview image as captured by the rear-facing camera is displayable;
an image viewfinder module implemented at least partially in hardware to:
determine a semi-folded state of the foldable display screen in which an entirety of the foldable display screen is positioned in a direction toward a user of the wireless device, with a portion of the foldable display screen unviewable by the user in the semi-folded state;
determine that an eye gaze of the user correlates with the portion of the foldable display screen that is unviewable by the user in the semi-folded state of the foldable display screen; and
initiate to display the viewfinder user interface on an approximate half section of the foldable display screen for viewability based on the determined eye gaze of the user, the semi-folded state of the foldable display screen, and the camera preview image being displayed in the viewfinder user interface.

2. The wireless device as recited in claim 1, wherein:
the foldable display screen includes a lower display section and an upper display section; and
the image viewfinder module initiates to display the viewfinder user interface on one of the lower display section or the upper display section.

3. The wireless device as recited in claim 2, wherein the image viewfinder module is configured to:
receive a camera image view as an input from a front-facing camera of the wireless device;
determine that a user of the wireless device is not positioned to view the upper display section of the foldable display screen in the semi-folded state based on input of the camera image view from the front-facing camera; and
initiate the display of the viewfinder user interface on the lower display section of the foldable display screen.

4. The wireless device as recited in claim 2, wherein the image viewfinder module is configured to:
receive a camera image view as an input from a front-facing camera of the wireless device; and
determine an orientation of the wireless device relative to using the rear-facing camera to capture a digital image based on input of the camera image view from the front-facing camera.

5. The wireless device as recited in claim 2, wherein the image viewfinder module is configured to receive a user-selectable input to display the viewfinder user interface on the lower display section or the upper display section of the foldable display screen.

6. The wireless device as recited in claim 1, further comprising:
a device housing operable to rotate a first housing section relative to a second housing section to one of a closed position, an open position, or a semi-open position of the wireless device; wherein:
the foldable display screen includes a first display in the first housing section and a second display in the second housing section; and
the image viewfinder module initiates to display the viewfinder user interface on one of the first display or the second display in the semi-open position of the wireless device.

7. The wireless device as recited in claim 1, wherein the image viewfinder module is configured to:
receive an angle input that indicates an angle of the semi-folded state of the foldable display screen; and
initiate to display the viewfinder user interface on the approximate half section of the foldable display screen based on the angle input.

8. The wireless device as recited in claim 1, wherein the image viewfinder module is configured to:
receive sensor data that indicates a change in an angle of the foldable display screen from substantially open to the semi-folded state; and
initiate to display the viewfinder user interface on the approximate half section of the foldable display screen based on the sensor data.

9. The wireless device as recited in claim 1, wherein the image viewfinder module is configured to:
receive sensor data that indicates a change in an angle of the foldable display screen from the semi-folded state to substantially open; and
initiate to change the display of the viewfinder user interface from the approximate half section of the foldable display screen to display on substantially all of the foldable display screen based on the sensor data.

10. The wireless device as recited in claim 1, wherein the image viewfinder module is configured to:
receive sensor data and determine an orientation of the wireless device; and
initiate to display the camera preview image in a periscopic viewing mode of the viewfinder user interface.

11. A method, comprising:
capturing a camera preview image with a rear-facing camera of a wireless device;
displaying a viewfinder user interface that includes the camera preview image on a foldable display screen of the wireless device;
determining a semi-folded state of the foldable display screen in which an entirety of the foldable display screen is positioned in a direction toward a user of the wireless device, with a portion of the foldable display screen unviewable by the user in the semi-folded state;
determining that an eye gaze of the user correlates with the portion of the foldable display screen that is unviewable by the user in the semi-folded state of the foldable display screen; and
displaying the viewfinder user interface that includes the camera preview image on a bifurcated section of the foldable display screen for viewability based on the determined eye gaze of the user, the semi-folded state of the foldable display screen, and the camera preview image being displayed in the viewfinder user interface.

12. The method as recited in claim 11, further comprising:
receiving a camera image view as an input from a front-facing camera of the wireless device;
determining that a user of the wireless device is not positioned to view an upper display section of the foldable display screen in the semi-folded state based on input of the camera image view from the front-facing camera; and
initiating the display of the viewfinder user interface on a lower display section of the foldable display screen.

13. The method as recited in claim 11, further comprising:
receiving a camera image view as an input from a front-facing camera of the wireless device; and
determining an orientation of the wireless device relative to using the rear-facing camera to capture a digital image based on input of the camera image view from the front-facing camera.

14. The method as recited in claim 11, further comprising receiving a user-selectable input to display the viewfinder user interface on a lower display section or an upper display section of the foldable display screen.

15. The method as recited in claim 11, further comprising:
receiving sensor data that indicates a change in an angle of the foldable display screen from substantially open to the semi-folded state; and
displaying the viewfinder user interface on the bifurcated section of the foldable display screen based on the sensor data.

16. The method as recited in claim 11, further comprising:
receiving sensor data that indicates a change in an angle of the foldable display screen from the semi-folded state to substantially open; and
changing the display of the viewfinder user interface from the bifurcated section of the foldable display screen to display on substantially all of the foldable display screen based on the sensor data.

17. The method as recited in claim 11, further comprising:
determining an orientation of the wireless device based on sensor data; and
displaying the camera preview image in a periscopic viewing mode of the viewfinder user interface.

18. A system, comprising:
a rear-facing camera to capture a camera preview image;
a front-facing camera to capture a camera image view;
a foldable display screen to display a viewfinder user interface in which the camera preview image as captured by the rear-facing camera is displayable, an entirety of the foldable display screen positioned in a direction toward a user in a semi-folded state, with a portion of the foldable display screen unviewable by the user in the semi-folded state;
an image viewfinder module implemented at least partially in hardware to:
determine that an eye gaze of the user correlates with the portion of the foldable display screen that is unviewable by the user in the semi-folded state of the foldable display screen;
determine that an upper display section of the foldable display screen is not viewable in the semi-folded state of the foldable display screen based on the determined eye gaze of the user and the camera image view from the front-facing camera; and
initiate to display the viewfinder user interface in which the camera preview image is displayed on a lower display section of the foldable display screen in the semi-folded state.

19. The system as recited in claim 18, wherein the image viewfinder module is configured to:
receive an angle input that indicates an angle of the semi-folded state of the foldable display screen; and
initiate to display the viewfinder user interface on the lower display section of the foldable display screen based on the angle input.

20. The system as recited in claim 18, wherein the image viewfinder module is configured to:
receive sensor data that indicates a change in a configuration of the foldable display screen from substantially open to the semi-folded state; and
initiate to display the viewfinder user interface on the lower display section of the foldable display screen based on the sensor data.
